(19) United States
(12) Patent Application Publication
(10) Pub. No.: US 2001/0055454 A1
(43) Pub. Date: Dec. 27, 2001

(54) Fiber carrying light emitting elements having patterned insulation

(76) Inventors: William R. Roach, Rocky Hill, NJ (US); Judith A. Ladd, Hamilton Township, NJ (US); Grzegorz Kaganowicz, Belle Mead, NJ (US); Daniel J. Szostak, Hamilton Square, NJ (US)

Correspondence Address: DANN DORFMAN HERRELL & SKILLMAN, SUITE 720, 1601 MARKET STREET, PHILADELPHIA, PA, 19103-2307, US

(21) Appl. No.: 09/858,848

(22) Filed: May 16, 2001

Related U.S. Application Data
(60) Provisional application No. 60/213,568, filed on Jun. 22, 2000.

(51) Int. Cl. G02B 6/16

(52) U.S. Cl. 385/123; 385/40

(57) ABSTRACT

A light-emitting fiber comprises an optical fiber having a number of light-emitting elements disposed along the length of one surface thereof. The light-emitting elements include a hole injecting electrode on which a patterned insulation layer is disposed having openings defining pixel areas. An electro-luminescent material, such as an OLED material, is disposed at least on such pixel areas and a segmented electron injecting electrode on the OLED layer. The hole injecting electrodes are connected together by an electrical conductor disposed on a side surface of the optical fiber. Electrical contacts connect to the electron injecting electrode and are disposed, at least in part, so as to overlie transverse portions of the insulation layer.

This Application claims the benefit of U.S. Provisional Application Serial No. 60/213,568 filed Jun. 22, 2000.

The present invention relates to a fiber carrying light emitting elements and, in particular, to a fiber carrying light emitting elements having patterned insulation.

Conventional image displays for large image sizes, e.g., images exceeding about 750-1000 cm (about 30-40 inches), suffer the well known issues of requiring a display having a very substantial depth in the case of cathode ray tube displays and of alignment and image registration in the case of projection displays, as well as high cost. Such conventional displays, as well as more recent relatively-thin plasma display panels, are constructed in a manner that non-uniformity of only a few pixels or relatively small regions of the conventional display can have a significant deleterious effect on overall image quality that would be noticeable by a typical viewer and so renders the entire display unsatisfactory. Because such defects are not detectable until the display device is substantially complete and such display devices are not generally repairable, the entire display device is typically scrapped at great cost.

Thus there is a need for a display, particularly for a large image display, that is not only thin, but is desirably made of elements that are individually testable prior to final assembly and that are repairable if later found defective. One such display is a display based on a plurality of fibers carrying light-emitting elements disposed along their lengths (i.e. often referred to as a light-emitting fiber) wherein the fibers are disposed side-by-side in array. One such display and the light-emitting fibers therefor are described, for example, in published patent applications WO 00/51192 entitled “DISPLAY DEVICE” published Aug. 31, 2000 and WO 00/51402 entitled “FIBER CARRYING LIGHT EMITTING ELEMENTS” published Aug. 31, 2000.

It is desirable that the light-emitting fibers utilized in a fiber-based display be conveniently made and realize a substantial operating life. One factor for realizing a substantial operating life is to substantially reduce the ability of moisture and oxygen and other oxidizing agents that can reduce the lifetime of the light-emitting elements from reaching such elements.

Accordingly, there is a need for a light-emitting fiber that tends to be resistant to the moisture and oxidizing agents from reaching the light-emitting elements of a display fiber.

To this end, the fiber of the present invention comprises a length of a fiber of an optically transparent material; a first electrode layer disposed along the length of a first surface of the fiber, wherein the electrode layer includes a layer of an optically-transparent electrically conductive material, and a layer of insulating material disposed on the first electrode layer and patterned to define a plurality of openings along the length of the fiber exposing the first electrode layer. A light-emitting material is disposed at least in the openings of the layer of insulating material on the electrode layer, and a plurality of electrical contacts are disposed on the light-emitting material along the length of the fiber in one-to-one relation to the openings of the layer of insulating material.

### BRIEF DESCRIPTION OF THE DRAWING

The detailed description of the preferred embodiments of the present invention will be more easily and better understood when read in conjunction with the FIGURES of the Drawing which include:

FIGS. 1A through 1G are schematic diagrams illustrating a sequence of exemplary steps in the fabrication of an exemplary light-emitting fiber, in accordance with the invention;

FIGS. 2A, through 2D are schematic diagrams illustrating an alternative sequence of exemplary steps and an exemplary light-emitting fiber, in accordance with the invention;

FIG. 3 is a top view schematic diagram of an exemplary light-emitting fiber in accordance with the invention;

FIG. 4 is a side cross-sectional view schematic diagram of the exemplary fiber of FIG. 3;

FIG. 5 is a side cross-sectional view schematic diagram of an alternative embodiment of the exemplary fiber of FIG. 3; and

FIG. 6 is a side cross-sectional view schematic diagram illustrating a process useful in making the fiber in accordance with the invention.

In the Drawing, where an element or feature is shown in more than one drawing figure, the same alphanumeric designation may be used to designate such element or feature in each figure, and where a closely related or modified element is shown in a figure, the same alphanumerical designation primed may be used to designate the modified element or feature. Similarly, similar elements or features may be designated by like alphanumeric designations in different figures of the Drawing and with similar nomenclature in the specification, but in the Drawing are preceded by digits unique to the embodiment described. It is noted that, according to common practice, the various features of the drawing are not to scale, and the dimensions of the various features are arbitrarily expanded or reduced for clarity.

### DESCRIPTION OF THE PREFERRED EMBODIMENT

In accordance with the invention, a light-emitting fiber 100 has a plurality of light-emitting elements 180 disposed along the length of an elongated fiber 110. Light-emitting fiber 100 is fabricated on a ribbon or fiber 110 of conventional optically transmissive material, such as glass, borosilicate glass, soda-lime glass, quartz, sapphire, plastic, polymethyl-methacrylate (PMMA), polycarbonate, acrylic, Mylar, polyester, polyimide or other suitable material, to have along its length on one of its surfaces 112 (e.g., a top surface 112) a plurality of light-emitting elements 180. Light-emitting elements 180 include an electro-luminescent material, preferably an Organic Light-Emitting Diode (OLED) material, disposed between suitable electrodes. A quartz fiber may be preferred if chemical inertness is desired, and a plastic fiber may be preferred if greater flexibility is desired. Such ribbon or fiber is generally referred to herein as an optical fiber, it being understood that the material and physical size and shape of such ribbon or fiber may vary.

Each light-emitting element or OLED “stack” 180 includes at least a hole injecting electrode layer 120, a layer of light-emitting material 150 and an electron injector electrode 160, and is independently operable to produce one pixel of the image or information to be displayed. Alternatively light emission can occur in the electron (or hole) transport material in a region near the boundary with the hole (or electron) transport layer. In a color display, three physical pixel elements 180 may each produce one of three color sub-pixels that emit light of three different colors to together produce one color pixel of a color image.

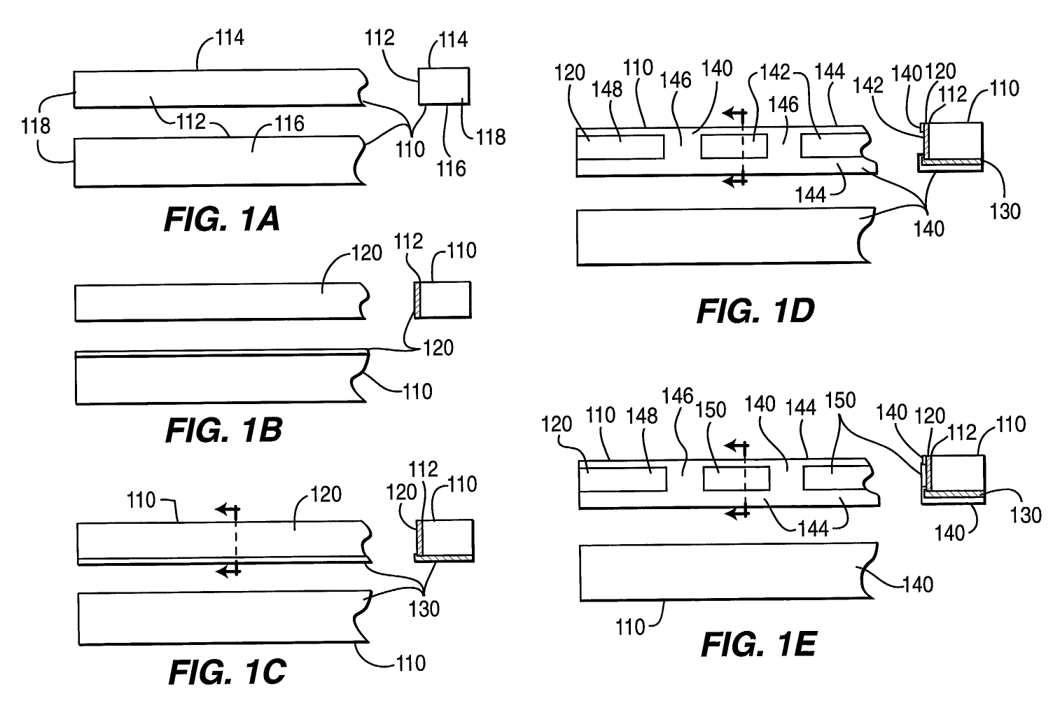

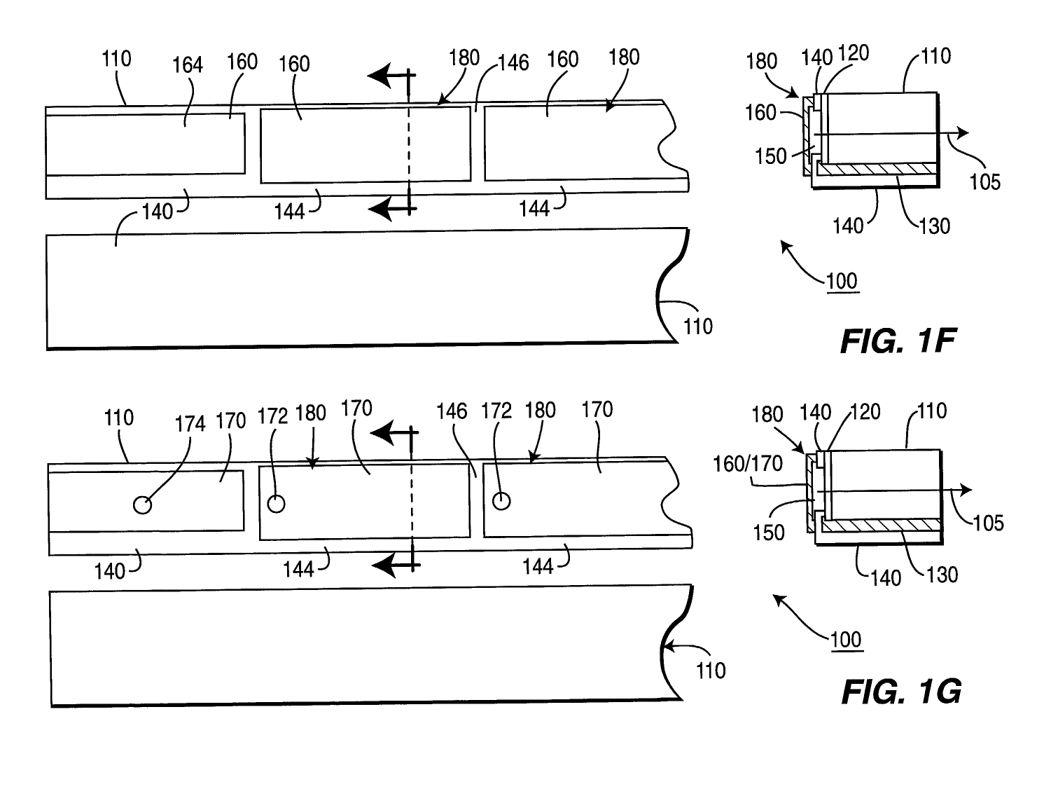

FIGS. 1A through 1G are schematic diagrams illustrating a sequence of steps in the fabrication of a light-emitting fiber 100 including the forming of light-emitting elements 180 on one surface thereof. Only a portion of fiber 110 and/or light-emitting fiber 100 is shown in FIGS. 1A-1G which each include a top view, a side view and an end view or cross-sectional view. A fiber 110 or other elongated member of an optically transmissive material, shown in top, side and end views in FIG. 1A, is provided and a thin layer of an optically transmissive, electrically-conductive material 120 on the top surface 112 thereof, as illustrated in FIG. 1B. Conductive layer 120, such as indium tin oxide (ITO), tin oxide, zinc oxide, a noble metal, combinations thereof, or another transparent hole-injecting material, serves as the hole injecting electrode of a later completed OLED light-emitting element or stack 180.

An electrically conductive bus 130, shown in FIG. 1C, is preferably of a highly conductive metal such as aluminum, copper, gold, chromium/gold (Cr Au) or silver, is deposited on or attached to one side 116 of optical fiber 110 and slightly overlaps the ITO 120 either on top surface 112 or on side surface 116. Conductive bus 130 makes electrical contact to ITO layer 120 for providing an electrical connection of relatively high electrical conductivity between the portion of hole injecting electrode 120 associated with each light-emitting element 180 and an input connection 170, 174 at one or both ends 118 of optical fiber 110.

Particularly in large displays, the lengths of conductor 130 may become long and the resistance of a thin-film or other deposited conductor 130 may be higher than desired. Conductor 130 may be made thicker than the thicknesses obtainable by vacuum deposition of metals, such as by attaching thin strips of metal foil (e.g., 25-50 μm thick) along the length of fiber 110 and connected at intervals or continuously to ITO layer 120 by a spot or line of electrically-conductive epoxy or adhesive. Such strips 130 may be of aluminum, copper, silver, gold or other suitable metal, and may be in place of or in addition to the deposited strips 130. Where a metal foil strip 130 is employed in addition to a deposited conductor 130, the metal foil strip may be attached to deposited conductor 130 by electrically-conductive epoxy or adhesive, or may be simply be compressed against deposited conductor 130 by the (insulated) side of an adjacent fiber 100.

FIG. 1D illustrates an arrangement of the layers of light-emitting fiber 100 that provides a patterned insulation layer 140 for the OLED light-emitting elements 180 later completed. Insulating layer 140 covers both edges of ITO layer 120 on the top 112 of fiber 110 as well as conductor 130 along side 116 of fiber 110. Insulating layer 140 is patterned on the top surface 112 of fiber 110 to define a plurality of openings 142 in the desired shape of the light-emitting elements 180. Preferably, because the area of each of the light-emitting elements 180 is desirably as large as possible to maximize the light produced and therefore the brightness of the display in which light-emitting fiber 100 is employed, rectangular elements 180 having opposing edges close to the edges of fiber 110 are desirable. Thus the width of the portion 144 of insulation layer 140 that is disposed along the edges of fiber 110 for defining two edges of openings 142 are typically as narrow as tolerances and processing allow, so long as sufficient width is present for fully enclosing the light-emitting material 150 later deposited. Similarly, the transverse portion 146 of insulation layer 140 defining the space between adjacent openings 142 is made narrow for increasing the area of openings 142 relative to the area of top surface 112 consistent with tolerances and the width thereof appropriate for insulation between adjacent elements 180 and contact with an upper electrode contact 170 later applied.

Insulation layer 140, which prevents or reduces moisture and other undesirable material from reaching the OLED light-emitting elements 180 while not interfering with the making of electrical connection thereto, furthers achieving long life and high performance of the OLED light-emitting elements 180. Suitable moisture barrier materials include silicon nitride, silicon dioxide, silicon oxynitride, silicon carbide, diamond-like carbon, and phosphorus-silicate glass, and are typically applied through a mechanical mask. Alternatively, insulation layer 140 may be formed of an organic layer, such as a layer of a photoresist material. The photoresist may be deposited by dip coating and/or spraying or other suitable method and then be exposed and developed, and then partially removed to form openings 142 exposing ITO electrode layer 120. The organic layer may also be selectively deposited, such as by screen printing or ink jet printing, in the pattern of layer 140. Another suitable type of material for insulation layer 140 is an epoxy that is selectively deposited in the desired pattern and is then cured by exposure to ultra-violet light. In each case, however, insulating layer 140 remains in place during the deposition of the OLED stack 150 and the electrode layer 160 and contact layer 170, and so must be processed to be fully compatible with the OLED and electrode materials and the processing thereof.

One advantage of the foregoing processes for forming insulation layer 140 is that insulation layer 140 is formed over a continuous layer 120 of ITO or other electrode material that is smooth and of uniform thickness over the entire area of a pixel or light-emitting element 180, as may not be the case where ITO layer 120 is patterned into segments corresponding to light-emitting elements. In addition, because the thickness of insulation layer 140 typically tends to taper from full thickness to zero thickness at the edges of opening 142, the tendency of high electric fields to be generated at the edges of light-emitting elements 180 is reduced from that where layer 140 has an abrupt or sharp edge.

Insulation layer 140 may also define an opening 148 at one or both ends 118 of fiber 110 at which ends ITO layer 120 is exposed for later making electrical connection to the hole-injecting electrode 120 of light-emitting elements 180 and to electrical conductor 130 providing a relatively high conductivity connection thereto. As described below, at least a layer 170 of high-conductivity material is deposited through opening 148 so as to provide a high-conductivity connection to high-conductivity longitudinal conductor 130.

Where conductor 130 wraps around from the side 116 of fiber to the top 112 thereof, it may be desirable for conductor 130 to also be deposited so as to overlie the portion of ITO layer 120 near end 118 of fiber 110 that will be exposed through opening 148. Electrical bus 130, which couples a drive signal to the ITO electrodes 120 of each light-emitting element 180 along the length of optical fiber 110, is preferably covered by insulation layer 140 for providing electrical insulation thereof, particularly when a plurality of fibers 100 are in side-by-side array, as in a display.

Next, a layer 150 of OLED material is deposited on ITO layer 120 and insulation layer 140, which OLED layer 150 may or may not be segmented, and in the simplest form need not be segmented. In the simplest form for fabrication, OLED layer 150 may be continuous, or it may preferably be deposited as segments 140 each overlying an opening 142 in insulation layer 140, as illustrated in FIG. 1E. OLED layer or stack 150 does not overlie opening 148 exposing the end of ITO layer 120. OLED stack 150 typically includes several different layers of material, each typically having a thickness of about 500 Å, or more or less. Preferably, OLED layer 150 at least completely covers the areas of ITO layer exposed through openings 142 and thus, as a result of tolerances, at least slightly overlie the edges of insulation layer 140 defining openings 142.

A segmented layer 160 of electron injecting material is deposited on OLED stack 150, typically through the same mask that is utilized for deposition of the OLED hole transport and electron transport layers of OLED stack 150. A relatively durable conductive segmented contact layer 170 is similarly deposited onto segmented electrode layer 160 with the segments of layers 160 and 170 in registration, as illustrated in FIGS. 1F and 1G, although the segments of layer 170 are typically slightly larger than those of layer 160. The segments of layer 170 extend slightly beyond the edges of OLED layer 150 so as to completely overlie the OLED layer 150 and to contact insulation layer 140 completely surrounding and isolating OLED layer 140, thereby to retard or prevent moisture and other contaminants from reaching OLED material 150.

Each stack of hole-injecting layer 120, light-emitting material 150 and electron-injecting material 160 provides a light-emitting element 180 to which electrical control signals are applied via conductors 120/130 and 160/170 for causing light-emitting elements 180 to emit light. The electrical control signals applied via conductors 120/130 are usually referred to as “select signals” where plural light-emitting fibers 100 are disposed side-by-side in a display, and the electrical control signals applied via conductors 160/170 are referred to as “data signals” because their amplitude or duration is controlled to affect the amount of light emitted by light-emitting elements 180. Where plural fibers 100 are, for example, disposed horizontally in a display, the electrical control signals applied via conductors 120/130 are usually referred to as “row selection” signals, and the electrical control signals applied via conductors 160/170 are referred to as “column select” signals.

The breaks between adjacent ones of the segments contact layer 170 overlie transverse portions 146 of insulation layer 140 separating adjacent openings 142 therein, preferably close to an end edge of each opening 142 so that a substantial part of each transverse portion 146 is covered by contact segment 170 for defining a contact 172 by which electrical connection can be made to the electron-injecting electrode 160 of light-emitting OLED elements 180. The segments of OLED layer 150 overlying openings 142 and of electron injecting/contact layers 160, 170 are thus of like pitch along the length of optical fiber 110, but segments of layer 170 are preferably offset so that each segment thereof 170 overlies one transverse portion 142 and provides a contact 172 to electrode 160 overlying the transverse portion 146.

Top electrode 160 may be a layer of magnesium, magnesium/silver, calcium, calcium/aluminum, lithium fluoride or lithium fluoride/aluminum, or any other stable electron injector. Contact layer 170 may be aluminum, gold, chromium/gold (Cr Au) or copper, for example, or any other durable high-conductivity material. Top electrodes 160 and contacts 170 are in one-to-one correspondence with one another and with a portion of ITO layer 120, separated by a light-emitting material layer 150, along the length of optical fiber 110. It is noted that contacts or connection sites 172, 174 shown in FIG. 1G may simply be locations designated such on conductor layer 170 or may be sites at which additional thickness of the conductive material of layer 170 or other compatible conductive material is build up for providing a more durable contact. Preferably, top electrodes 160 are completely surrounded and encapsulated by insulating layer 140 and/or contact layer 170.

Contacts 172 are durable and provide a durable contact structure to which conductors providing pixel data signals are connected, which data signal conductors (not shown) lie transverse to the length direction of light-emitting fibers 100 in an array of a display. Because insulating layer 140 lies under the contact 172 portion of contact layer 170, the connecting of such transversely oriented data signal conductors to such contact 172 cannot cause a short circuit between the hole injecting electrode layer 120 and the electron injecting electrode 150 of any light-emitting element 180. Even if a portion of OLED layer 150 were to underlie contact 172, it would not be a portion of OLED layer 150 that produces light and so any damage thereto would not affect operation of any light-emitting element 180. The deposition of contact layer 170 also produces a contact 174 at the end 118 of optical fiber 110 connecting directly to ITO end electrode 124 through hole 148 (there is no OLED layer 130 or insulator material 140 overlying ITO electrode layer 120) and electrical bus 130 at the end 118 of optical fiber 110 to provide a durable contact structure to which conductors providing row select signals are connected.

Thus, suitable electrical connections can be made to couple the select signal and the data signal to respective electrodes 120 and 160 of each light-emitting element 180 for controllably and selectively energizing each light-emitting element 180 to produce the pixels of an image to be displayed by a display including a plurality of light-emitting fibers 100 in parallel side-by-side array. These connections are made to the surface of the light-emitting fibers 100 on which the light-emitting elements are formed, and the light emitted thereby passes through the optical fiber 110 away from the light-emitting elements 180 to be observed by a viewer of such display. It is noted that because light-emitting fibers 100 may be of any desired length, and because any desired number of such fibers 100 may arrayed side-by-side, a thin panel display of virtually any desired size (height and width) may be assembled utilizing the present invention.

Light emitted by light-emitting element 180 passes through optical fiber 110 to be observed by a viewer of the display including light-emitting fiber 100, as is indicated by arrow 105. While the light is generated in OLED material 150, it passes through the ITO or other thin material of electrode 120 in the direction indicated by arrow 105. The presence of top electrode 160 and/or contact layer 170 overlying OLED layer 150 desirably reflects light from OLED material 150 and so tends to increase the light output along the direction of arrow 105.

Where, for example, optical fiber 110 is about 0.25 mm (about 0.010 inch) wide, electrical bus 130 may overlie ITO electrode 120 by about 25 μm (about 0.001 inch) and insulation layer 140 may overlie bus 130 and ITO electrode 120 by about 50 μm (about 0.002 inch) along each side 114, 116 of fiber 110. Each OLED segment 150 and top electrode 160 may overlie insulator 140 by about 25 μm (about 0.001 inch) and extends beyond the ends of opening 142 by about 50 μm (about 0.002 inch). Metal contact 170 extends to the sides 114, 116 of optical fiber 110 and extends beyond the ends of each OLED segment 150 and top electrode 160 by at least about 25 μm (about 0.001 inch). Metal contact 170 thus seals the OLED segments 150 and serves as a insulating layer or moisture barrier therefor. Alternatively, electrode layer 160 could be deposited through the same mask as defines segments of OLED layer 150 and contact layer 170 could be deposited through a mask providing the dimensions described. Fiber 110 is generally of rectangular cross-section having an aspect ratio of thickness to width typically ranging between about 1:1 and 5:1. If fiber 110 is about 0.25 mm (about 0.010 inch) wide, it is typically about 0.25-1.25 mm (about 0.010-0.05 inch) thick. If fiber 110 is about 0.38 mm (about 0.015 inch) wide, it is preferably about 1.5-1.9 mm (about 0.060-0.75 inch) thick.

Where light-emitting fiber 100 is utilized in a color display, light-emitting elements 180 emitting three different colors of light, such as red (R), green (G) and blue (B), are utilized. The three different color light-emitting elements 180R, 180G, 180B are arranged to be in adjacent sets of R, G, B elements, each set providing a color pixel. Such arrangement of light-emitting elements 180R, 180G, 180B may be provided by sequencing R, G and B OLED materials 130 along the length of each light-emitting fiber 100 or may be provided by placing fibers 100 of different colors side-by-side in an R-G-B sequence, i.e. a red-emitting fiber 100R next to a green-emitting fiber 100G next to a blue-emitting fiber 100B and so forth. Red-emitting fiber 100R, green-emitting fiber 100G, and blue-emitting fiber 100B may be fabricated on ribbons or fibers 100 that are each tinted to the desired color or may employ different light-emitting materials that respectively emit the desired color.

Suitable small molecule OLED structures are known and include ITO as the hole injector, green-emitting OLED fabricated from naththyl-substituted benzidine derivative (NPB) as the hole transport layer, tris-(8-hydroxyquinoline) aluminum (Alq₃) as the electron transport layer, and magnesium/silver as the cathode, which are available commercially from Aldrich Chemical Company located in Milwaukee, Wis. and are reported by E. W. Forsythe et al in Extended Abstracts of The Fourth International Conference on the Science and Technology of Display Phosphors & 9th International Workshop on Inorganic and Organic Electroluminescence, Sep. 14-17, 1998, at page 53.

Red emission is obtained by doping the Alq₃ layer in the foregoing OLED structure doped with 6% 2,3,7,8,12,13,17,18-octaethyl-21H,23H-porphine platinum (II) (PtOEP) as reported by D. F. O'Brien et al in the Extended Abstracts of The Fourth International Conference on the Science and Technology of Display Phosphors & 9th International Workshop on Inorganic and Organic Electroluminescence, Sep. 14-17, 1998, at page 37 et seq. Blue emission is obtained in the foregoing OLED structure by including an additional layer. This OLED structure includes spiro-linked TAD (spiro-TAD) as the hole transport layer, spiro-linked sexiphenyl (spiro-6Φ) as the blue emitter layer, and Alq₃ as the electron transport layer as reported by Frank Weissortel et al in Extended Abstracts of The Fourth International Conference on the Science and Technology of Display Phosphors & 9th International Workshop on Inorganic and Organic Electroluminescence, Sep. 14-17, 1998, at page 5 et seq.

Small-molecule OLED materials may be applied by evaporation and polymer OLED materials may be deposited as monomers, for example, using ink jet printing, roller coating, screen printing and the like to deposit mixtures of the OLED material and suitable solvents as is known, and subsequently evaporating the solvent(s) and polymerizing the monomer by heating.

For a polymer OLED structure, ITO may be employed as the hole injector layer and polyethylene dioxythipene, commonly known as PEDOT, doped with polystyrene sulfonic acid (PEDOT:SS) available from by Bayer A. G. located in Ludwigshafen, Germany, or PVK poly-N-carbazole available from Aldrich Chemicals, as the hole transport layer. The electron transport/emissive layer can by a poly(fluorene)-based polymer for green emission, and other polymers for red and blue emission, as reported by J. H. Burroughes in the Extended Abstracts of The Fourth International Conference on the Science and Technology of Display Phosphors & 9th International Workshop on Inorganic and Organic Electroluminescence, Sep. 14-17, 1998, at page 133 et seq. A thin layer of a material that enhances hole injection, such as of copper pthalocyanine, e.g., about 100 Å thick, may be utilized.

Such green-emitting OLED materials typically provide brightness levels of about 100 cd/m² and exhibit power efficiencies of about 1, 11 and 5 lumens/watt for the R, G and B materials, respectively.

Contact layer 170 preferably extends beyond the length and width of OLED layer 150 (visible in FIGS. 1F and 1G) to surrounding OLED layer 150. To prevent contact layer 170 from electrically shorting to ITO layer 120 or to electrical bus 130, insulation layer 140 covers electrical select bus 130 on side 116 of optical fiber 110 and covers the edge of ITO layer 120 proximal side 114 of fiber 110. To avoid the need for electrical bus 130 to wrap around from side 116 to top 112 of fiber 110 so as to overlap the edge of ITO layer 120, it may be desirable to apply ITO layer 120 and electrical conductor 130 in the opposite order to that described above.

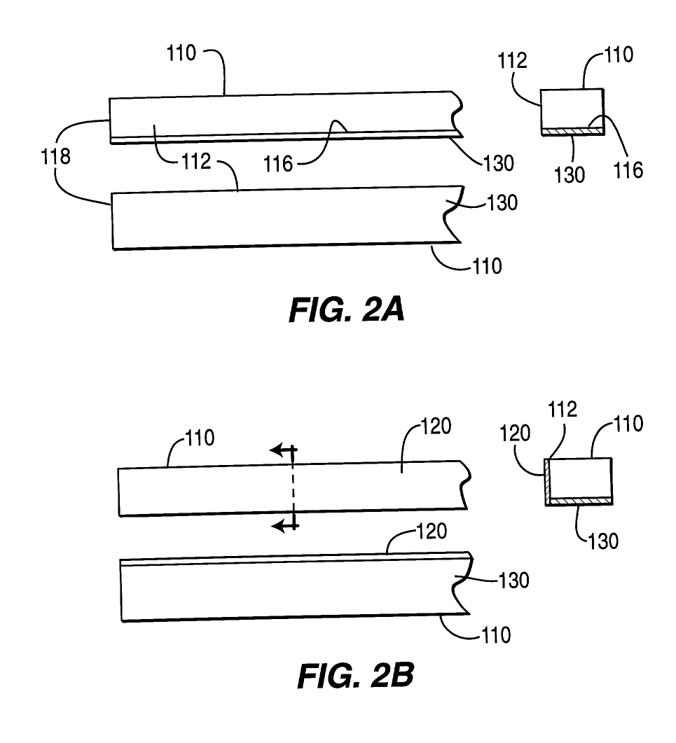

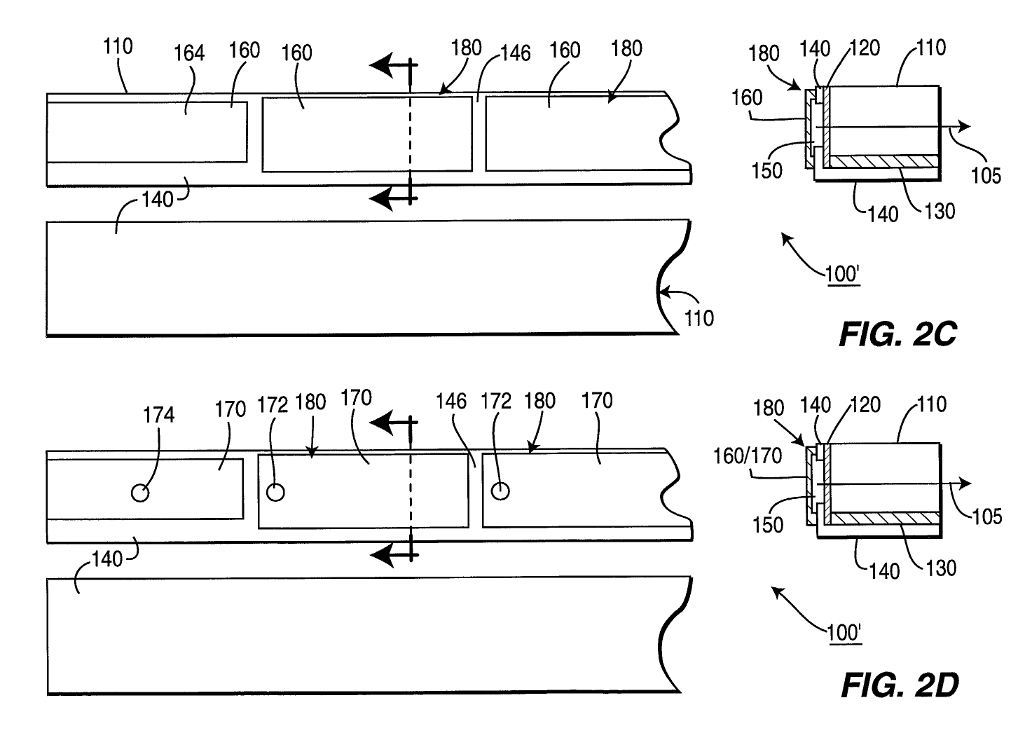

FIGS. 2A, 2B, 2C and 2D are schematic diagrams illustrating an alternative sequence of steps and a light-emitting fiber 100 according to the invention. FIG. 2A illustrates a fiber 110 as in FIG. 1A on which an electrical conductor 130 as above is deposited along the length of fiber 110 on side 116 thereof and extending at least to the edge between side 116 and top 112 thereof. FIG. 2B illustrates an ITO or similar light-transmissive layer 120 as above deposited onto the fiber 110 of FIG. 2A so that ITO layer 120 covers top surface 112 of fiber 110 as well as at least the edge of conductor 130 for making electrical contact thereto along the length of fiber 110.

The light-emitting fiber 100 resulting from the processing of fiber 110 of FIG. 2B according to the sequence of FIGS. 1D through 1G is illustrated in FIGS. 2C and 2D. The structure and operation of fiber 100′ of FIGS. 2C and 2D is the same as that of fiber 100 of FIGS. 1F and 1G, respectively, except for the particular structure of the connection of ITO layer 120 and conductor 130 at the juncture of side 116 and top 112 surfaces of fiber 110.

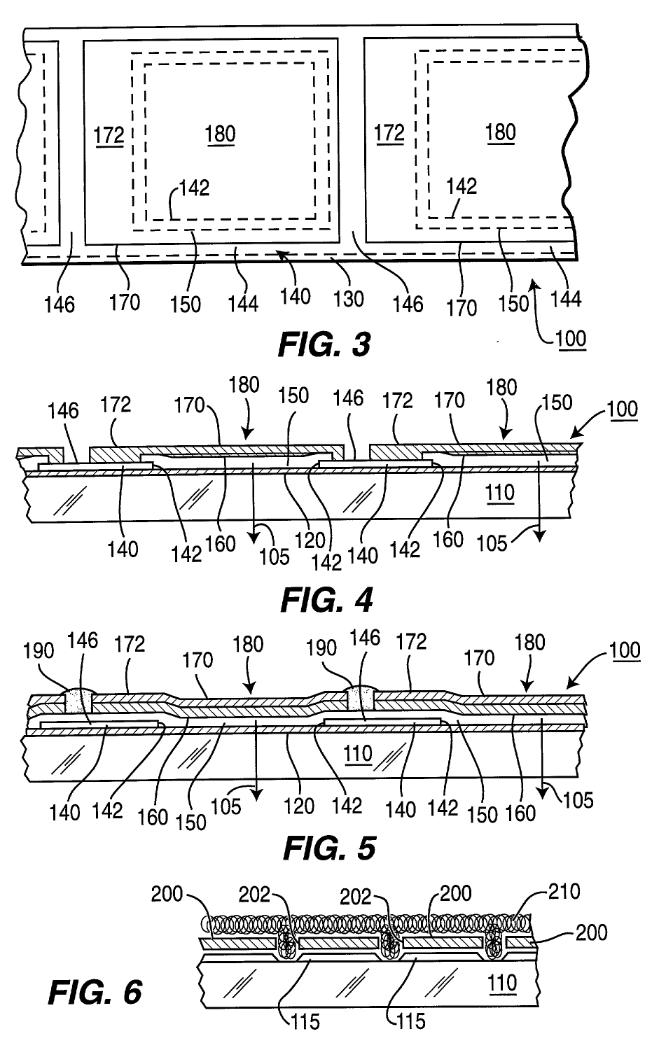

FIG. 3 is a top view schematic diagram of an exemplary light-emitting fiber 100, and FIG. 4 is a side view cross-sectional view schematic diagram of the exemplary fiber of FIG. 3, in accordance with the invention. Fiber 100 illustrates the relative registration and alignment of the various elements comprising the light-emitting elements 180 disposed along the length of fiber 100. A continuous layer 120 of ITO is disposed on the surface of elongated fiber 110 and a patterned layer 140 of a insulation material or isolating material is deposited on ITO layer 120. The pattern of layer 140 includes a plurality of generally rectangular openings 142 defining the active pixel areas 180 of fiber 100, i.e. the light-emitting element 180 areas thereof.

Light-emitting elements 180 are comprised of OLED material 150 disposed on hole-injecting ITO layer 120 in openings 142 of isolating layer 140 and extending slightly beyond opening 142 so as to slightly overlap onto isolating layer 140. Electron-injecting layer 160 is disposed on OLED layer 150 and is at least as large as opening 142 so as to provide a light-emitting stack 180 that produces light over the entire area defined by opening 142. Patterned electrically conductive layer 170 provides a contact that overlies electrode layer 160 and extends beyond the edges of OLED layer 150 so as to form a seal with isolating layer 140 by which OLED material 150 is completely surrounded or encapsulated or isolated from the external environment so as to be relatively impervious to moisture and other potentially degrading contamination, as is shown in FIGS. 3 and 4.

The patterns of electrode layer 160 and of contact layer 170 are substantially registered and aligned with each other so as to overlie and extend beyond the pattern of OLED material layer 150 for sealing same as described above, and are registered longitudinally along the length of fiber 110 so as to have gaps overlying the transverse portions 146 of patterned isolating layer 140. The longitudinal registration is such that the gap between adjacent contacts 170 is skewed towards one end of transverse isolating portion 146 so that a substantial area of each segment of layer 170 overlies transverse portion for providing a region or contact 172 to which electrical connection may be made. This beneficially provides for electrical connections being made at locations that do not overlie an active area of light-emitting material 150, i.e., the light-emitting element 180 areas defined by the pattern openings 142 of isolating layer 140, so that connections may be made without damaging the active light-emitting element 180, thereby potentially increasing the yield of operating pixel elements along any length of light-emitting fiber 100.

FIG. 5 is a side view cross-sectional view schematic diagram of an alternative embodiment of exemplary fiber 100 in which OLED layer 150 is not patterned into segments as shown in FIGS. 3 and 4, but is a continuous longitudinal strip 150′ disposed along the length of fiber 100. The portion of OLED layer 150′ overlying transverse isolating portions 146 is not part of the active or light-emitting area of light emitting elements 180 and so does not produce light. Thus, operation of light-emitting elements 180 is not affected if damage should occur to the portion of OLED layer 150′ outside of the active area of elements 180. While electrode layer 160 is illustrated therein, for example, as being substantially coextensive with electrically-conductive layer 170, i.e. contact layer 170, it could be of lesser extent, e.g., as illustrated in FIG. 4.

An advantage of the arrangement of FIG. 5 is that the deposition of OLED layer 150′ is somewhat simpler that is the deposition of a segmented OLED layer 150 as illustrated in FIG. 4. If desired, the exposed portion of OLED layer 150′, that is the portion exposed by the gaps between adjacent segments of contact layer 170, may be passivated by filling the gap with insulation material 190, which may be one of the insulation materials described above. Alternatively, gap-filling material 190 may be an epoxy that is applied in a dry, ambient environment at room temperature and ambient pressure. A suitable type of encapsulant is an epoxy that is cured by exposure to ultra-violet light and so will not require an elevated temperature that might adversely affect OLED material 150.

While the present invention has been described in terms of the foregoing exemplary embodiments, variations within the scope and spirit of the present invention as defined by the claims following will be apparent to those skilled in the art. For example, top electrode layer 160 and/or contact layer 170 thereon may be formed as segments as illustrated, e.g., using a mechanical mask, or may be deposited in a continuous strip along the length of fiber 100 which is later segmented by scribing transverse gaps over transverse portions 146 of insulation layer 140. Such scribing can be by mechanical scribing, by laser scribing, or by a fine saw, for example.

Further, if it is desired that ITO layer 120 be segmented to correspond to the segments of the OLED material 150, electrode material 160 and/or contact material, such may be provided by evaporating or sputtering layer 120 through a mechanical mask. Alternatively, a continuous ITO layer 120 may be formed and then be segmented, such as by wet or dry or chemical etching using a photoresist or a mechanical mask to define the pattern thereof. A preferred patterning method is to etch the material 115 on fiber 110 to be removed by exposing it to a plasma 210 through openings 202 in a mechanical mask 200, because the turbulence of the etching plasma 210 tends to produce a tapered edge, rather than a sharp or abrupt edge, as illustrated in the side cross-sectional view schematic diagram of FIG. 6. Material 115 to be removed may include, e.g., ITO layer 120, insulating material 140, light-emitting material 150, electrode material 160, and/or contact material 170.

It should be noted that a display including a plurality of light-emitting fibers 100 may be arranged with the fibers 100 lying either in a vertical or horizontal direction, or in any other direction, as may be convenient and desired. For a display having a conventional 4:3 or 16:9 aspect ratio, disposing fibers 100 vertically results in a relatively shorter fiber, however, a greater number of such fibers is required.

What is claimed is:

1. A fiber comprising:
a length of a fiber of an optically transparent material;
a first electrode layer disposed along the length of a first surface of said fiber, wherein said electrode layer includes a layer of an optically-transparent electrically conductive material;
a layer of insulating material disposed on the first electrode layer and patterned to define a plurality of openings exposing the first electrode layer;
a light-emitting material disposed at least in the openings of said layer of insulating material on said electrode layer; and
a plurality of electrical contacts disposed on the light-emitting material in one-to-one relation to the openings of said layer of insulating material, wherein the light-emitting material disposed between said electrode layer and a given one of said electrical contacts emits light responsive to an electrical signal applied between said electrode layer and said given one electrical contact.

2. The fiber of claim 1 wherein the optically-transparent material includes at least one of glass, borosilicate glass, soda-lime glass, quartz, sapphire, plastic, polymethyl-methacrylate (PMMA), polycarbonate, acrylic, Mylar, polyester, and polyimide.

3. The fiber of claim 1 wherein the optically-transparent electrically conductive material includes at least one of indium tin oxide, tin oxide, zinc oxide, a noble metal, and combinations thereof.

4. The fiber of claim 1 wherein said light-emitting material includes one of an inorganic electro-luminescent material and an organic light-emitting material.

5. The fiber of claim 1 wherein said electrical contacts include at least one layer of at least one of magnesium, magnesium/silver, calcium, calcium/aluminum, lithium fluoride and lithium fluoride/aluminum, aluminum, gold, silver, copper, chromium, alloys thereof, and combinations thereof.

6. The fiber of claim 1 further comprising an elongated electrical conductor disposed along the length of said fiber on a second surface thereof that is contiguous to the first surface thereof, wherein said elongated electrical conductor is in electrical contact with said electrode layer along the length of said fiber.

7. The fiber of claim 6 wherein said elongated electrical conductor includes at least one of aluminum, gold, silver, copper, chromium, alloys thereof, and combinations thereof.

8. The fiber of claim 1 wherein said insulating material includes at least one of silicon nitride, silicon dioxide, silicon oxynitride, silicon carbide, diamond-like carbon, phosphorus-silicate glass, photoresist, and ultraviolet curable epoxy.

9. The fiber of claim 1 wherein said electrical contacts extend beyond an edge of said light-emitting material so as to be disposed on said layer of insulating material.

10. The fiber of claim 1 wherein each of said plurality of electrical contacts includes a portion that overlies a transverse portion of said layer of insulating material between adjacent ones of the openings therethrough, the extending portion of said electrical contact being adapted for receiving an electrical connection.

11. The fiber of claim 1 wherein the electrical contact closest to a first end of said length of fiber is disposed on said electrode layer in direct electrical contact without intervening light-emitting material.

12. A fiber having a plurality of light-emitting elements disposed along its length, comprising:
a length of a fiber of an optically transparent material;
a plurality of light-emitting elements on a first surface of said fiber; and
an elongated electrical conductor disposed along the length of said fiber on a second surface thereof that is contiguous to the first surface thereof, said elongated electrical conductor being adapted for receiving a first electrical signal;
said plurality of light-emitting elements including:
a first electrode layer disposed on the first surface along the length of said fiber, wherein first electrode layer includes a layer of an optically-transparent electrically conductive material electrically connected to said elongated electrical conductor, whereby said elongated electrical conductor provides a first electrode connection common to all said light-emitting elements,
a layer of insulating material disposed on the first electrode layer and patterned to define a plurality of openings along the length of the fiber exposing the first electrode layer;
a light-emitting material disposed at least on said first electrode layer in the openings of said layer of insulating material to provide light-emitting material for each of said light-emitting elements,
a plurality of second electrodes disposed along the length of said fiber on the light-emitting material in one-to-one correspondence with the openings of said layer of insulating material, each of said plurality of second electrodes defining a second electrode of one of said plurality of light-emitting elements, and
a plurality of electrical contacts disposed along the length of said fiber on the second electrodes in one-to-one correspondence with the openings of said layer of insulating material, each of said plurality of electrical contacts being adapted for receiving a second electrical signal,
whereby the light-emitting material disposed between corresponding ones of said first and second electrodes is adapted to emit light responsive to first and second electrical signals applied between said elongated electrical conductor and ones of said plurality of electrical contacts, respectively.

13. The fiber of claim 12 wherein the optically-transparent material includes at least one of glass, borosilicate glass, soda-lime glass, quartz, sapphire, plastic, polymethyl-methacrylate (PMMA), polycarbonate, acrylic, Mylar, polyester, and polyimide.

14. The fiber of claim 12 wherein the optically-transparent electrically conductive material includes at least one of indium tin oxide, tin oxide, zinc oxide, a noble metal, and combinations thereof, and wherein said plurality of second electrode segments includes at least one layer of at least one of magnesium, magnesium/silver, calcium, calcium/aluminum, lithium fluoride and lithium fluoride/aluminum.

15. The fiber of claim 12 wherein at least one of said plurality of electrical contacts and said elongated electrical conductor includes at least one of aluminum, gold, silver, copper, chromium, alloys thereof, and combinations thereof.

16. The fiber of claim 12 wherein said light-emitting material includes one of an inorganic electro-luminescent material and an organic light-emitting material.

17. The fiber of claim 12 wherein said insulating material includes at least one of silicon nitride, silicon dioxide, silicon oxynitride, silicon carbide, diamond-like carbon, phosphorus-silicate glass, photoresist, and ultraviolet curable epoxy.

18. The fiber of claim 12 wherein each of said plurality of electrical contacts includes a portion that extends beyond the opening of said layer of insulating material to overlie a transverse portion of said layer of insulating material between adjacent ones of the openings therethrough, the extending portion of said electrical contact being adapted for receiving an electrical connection.

19. The fiber of claim 12 wherein each of said plurality of electrical contacts includes a portion that overlies a transverse portion of said layer of insulating material between adjacent ones of the openings therethrough, the extending portion of said electrical contact being adapted for receiving an electrical connection.

20. The fiber of claim 12 wherein the electrical contact closest to a first end of said length of fiber is disposed on said electrode layer in direct electrical contact without intervening light-emitting material.

21. A fiber including a light-emitting element disposed thereon comprising;
an optical fiber having a top surface and first and second side surfaces contiguous to the top surface;
a first electrode of an optically transparent electrically conductive material along the top surface of said optical fiber and extending substantially the width of the top surface;
a layer of electrical conductor on the first side surface of said optical fiber including a portion extending to the juncture of the top surface and the first side surface thereof to connect to said first electrode;
a patterned layer of insulating material having edge portions overlying opposing edges of said first electrode on the first surface of said optical fiber proximal the first and second sides of said optical fiber, said patterned layer of insulating material having a plurality of transverse portions extending transversely between the edge portions thereof, thereby to define a plurality of openings in said patterned layer of insulating material;
a layer of a light emitting material including one of an inorganic electro-luminescent material and an organic light-emitting material disposed at least on said first electrode in the openings of said patterned layer of insulating material, wherein said layer of light-emitting material is spaced away from the edges where the first and second side surfaces of said optical fiber meet the top surface thereof;
a plurality of second electrode segments of electrically conductive material disposed on the layer of light emitting material in registration with the openings of said patterned layer of insulating material; and
a plurality of electrical contacts of electrically conductive metal disposed on the second electrode and extending beyond said layer of light-emitting material to lie on said patterned layer of insulating material, the extending portion of said electrical contact being adapted for electrical connection.

22. The fiber of claim 21 wherein said layer of light-emitting material extends along the length of said optical fiber to overlie at least one of the transverse portions of said patterned layer of insulating material, further including a insulating material overlying at least the light-emitting material overlying the transverse portions of said patterned layer of insulating material, whereby the light-emitting material is covered by the electrical contacts and the insulating material.

23. The fiber of claim 21 wherein the layer of electrical conductor on the first side surface of said optical fiber includes a portion extending to the juncture of the top surface and the first side surface thereof to overlie the first electrode on the top surface of said optical fiber to connect said electrical conductor to said first electrode.

24. The fiber of claim 21 wherein said first electrode extends beyond the width of said optical fiber at the juncture of the top surface and the first side surface thereof to overlie said layer of electrical conductor on the first side surface of said optical fiber to connect said first electrode to said electrical conductor.

25. A method for making a fiber having a plurality of light-emitting elements thereon comprising:
providing a length of fiber having a first surface;
depositing a first electrode along the length of fiber on the first surface;
depositing a patterned insulating material having edge portions overlying opposing edges of the first electrode on the first surface of the fiber proximal opposing edges thereof, the patterned insulating material having a plurality of transverse portions extending transversely between the edge portions thereof, thereby to define a plurality of openings in the patterned insulating material;
depositing a light-emitting material at least on the first electrode in the openings of the patterned insulating material, wherein the light-emitting material is spaced away from the edges of the first surface of the fiber; and
depositing a plurality of electrical contacts on the light-emitting material and extending beyond the light-emitting material to lie on the patterned insulating material, the extending portion of the electrical contact being adapted for electrical connection.

26. The method of claim 25 wherein said depositing a plurality of electrical contacts includes first depositing a plurality of spaced-apart second electrode segments on the light-emitting material substantially overlying the openings of the patterned insulating material, and then depositing the plurality of electrical contacts on the plurality of second electrodes.

27. The method of claim 25 wherein the light-emitting material extends along the length of the fiber to overlie at least one of the transverse portions of the patterned insulating material, further including applying an insulating material on at least the light-emitting material overlying the transverse portions of the patterned insulating material, whereby the light-emitting material is covered by the electrical contacts and the insulating material.

28. The method of claim 25 wherein said depositing a first electrode includes depositing at least one of indium tin oxide, tin oxide, zinc oxide, a noble metal, and combinations thereof, and wherein said depositing a plurality of electrical contacts includes depositing at least one of magnesium, magnesium/silver, calcium, calcium/aluminum, lithium fluoride, lithium fluoride/aluminum, aluminum, gold, silver, copper, chromium, alloys thereof, and combinations thereof.

29. The method of claim 25 further comprising patterning at least one of the first electrodes, the patterned insulating material and the plurality of electrical contacts by one of scribing, laser scribing, photo etching, plasma etching, wet chemical etching and dry chemical etching.

30. The method of claim 25 wherein said depositing a patterned insulating material includes depositing at least one of silicon nitride, silicon dioxide, silicon oxynitride, silicon carbide, diamond-like carbon, phosphorus-silicate glass, photoresist, and ultraviolet curable epoxy.
